(19) United States
(12) Patent Application Publication
(10) Pub. No.: US 2025/0058343 A1
(43) Pub. Date: Feb. 20, 2025

(54) Dual-Size Sprinkler Head Riser Device

(71) Applicant: Lisa Souza, Cape Coral, FL (US)

(72) Inventor: Lisa Souza, Cape Coral, FL (US)

(21) Appl. No.: 18/733,972

(22) Filed: Jun. 5, 2024

Related U.S. Application Data
(60) Provisional application No. 63/519,359, filed on Aug. 14, 2023.

(51) Int. Cl. B05B 15/65

(52) U.S. Cl. CPC B05B 15/65

(57) ABSTRACT

A dual-size sprinkler head riser device is provided. The device is comprised of a first end comprised of a first opening that can be secured to a sprinkler pipe. A second end of the device is comprised of a second opening, wherein a sprinkler body can attach to the second end via a fastener of the body. The body can preferably be cut to size by a user to provide a customizable sprinkler head riser. Further, the diameters of each opening may differ to allow the device to remain compatible with a pipe of a first diameter and a sprinkler body of a second diameter.

### CROSS-REFERENCE TO RELATED APPLICATION

The present application claims priority to, and the benefit of, U.S. Provisional Application No. 63/519,359, which was filed on Aug. 14, 2023, and is incorporated herein by reference in its entirety.

### FIELD OF THE INVENTION

The present invention relates generally to the field of sprinkler head risers. More specifically, the present invention relates to a dual-size sprinkler head riser device that provides a sprinkler head riser that can be used to raise sunken sprinklers or simply replace broken sprinkler heads at the same height without having to replace the funny elbows attached to the water pipeline with different diameters. Accordingly, the present disclosure makes specific reference thereto. Nonetheless, it is to be appreciated that aspects of the present invention are also equally applicable to other like applications, devices, and methods of manufacture.

### BACKGROUND

Addressing the issue of sprinkler heads that have either broken or have sunk too far into the ground can often be a challenging and cumbersome endeavor. Typically, the attachment point on many sprinkler heads have a ½″ female connection, while a replacement sprinkler riser may have a ¾″ female connection. This provides an inconvenient compatibility and requires a user invest extra cost and effort and potentially use additional tools and parts for a successful installation.

Further, the task of changing a funny elbow connection of a sprinkler is another challenge that isn't always straightforward. This is due to the need to delve deep into the ground to access the elbow that's firmly attached to the underlying pipe, a process that's not only labor-intensive but also time-consuming.

Therefore, there exists a long-felt need in the art for a device that allows a broken sprinkler head to be easily replaced and can be used to raise a sunken sprinkler if needed. There also exists a long-felt need in the art for a dual-size sprinkler head riser device. More specifically, there exists a long-felt need in the art for a dual-size sprinkler head riser device that provides connection points that can accommodate two different diameters of sprinkler bodies and funny elbows connected to water pipelines. In addition, there exists a long-felt need in the art for a dual-size sprinkler head riser device that can be easily replaced by a user without added labor or expenses.

The subject matter disclosed and claimed herein, in one embodiment thereof, comprises a dual-size sprinkler head riser device. The device is comprised of a first end comprised of a female first opening that can be secured to a male funny elbow attached to a sprinkler pipeline. A second end of the device is comprised of a male second opening, wherein a sprinkler head body can attach to the second end via the female end of the sprinkler head body. The body can preferably be cut to size by a user to provide a customizable sprinkler head riser. Further, the diameters of each opening may differ to allow the device to remain compatible with funny elbow attached to the water pipeline of a first diameter and a sprinkler head body of a second diameter.

In this manner, the dual-size sprinkler head riser device of the present invention accomplishes all the foregoing objectives and provides a device that allows a sprinkler head to be easily replaced and can be used to raise a sunken sprinkler that needs replaced. The device also provides connection points that can accommodate two different diameters of sprinkler bodies and pipes to convert the diameter of either the funny elbow attached to the water pipeline or the diameter of the sprinkler head itself without the need for any other device. In addition, the device can be easily replaced by a user thus saving labor time and the cost of using only one device.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a dual-size sprinkler head riser device. The device is primarily comprised of a body with a first end and a second end. The first end is comprised of at least one fastener that allows a sprinkler body to attach to the device. The first end and second end preferably differ in diameter to allow easy attachment to sprinkler bodies and elbow pipes to raise sprinkler bodies that have sunk too low into the ground.

The body is preferably tubular and hollow to allow fluid to travel from an elbow pipe, through the body, and to a sprinkler body. The first end of the body is comprised of at least one opening. The interior surface of the opening is comprised of at least one fastener that allows the first end to attach to at least one fastener of an elbow pipe. The opening is preferably of a first diameter.

The second end of the body is also comprised of at least one opening of a second diameter. The exterior surface of the body is preferably comprised of at least one fastener that allows the second end of the body to attach to a fastener of a sprinkler. The opening is preferably of a second diameter. As a result of the presence of the fastener on the exterior surface of the body, the body can be cut to size by a user in order to achieve the proper body height needed for the sprinkler and elbow pipe connection. In various embodiments, the diameters of each opening may be identical or different in order to facilitate attachment with any different diameters of elbow pipe and sprinkler body known in the art.

The present invention is also comprised of a method of using the device. First, a device is provided comprised of a body comprised of an exterior surface comprised of a fastener, a first end with an opening comprised of at least one fastener, and a second end comprised of an opening. Then, a fastener of an elbow pipe can be secured to a fastener of the first end. Finally, the fastener can be secured to the fastener of a sprinkler body at the second end.

The present invention is also comprised of a second method of using the device. First, a device is provided comprised of a body comprised of an exterior surface comprised of a fastener, a first end with an opening comprised of at least one fastener, and a second end comprised of an opening. Then, a fastener of an elbow pipe can be secured to a fastener of the first end. Next, the body can be cut to the desired size by a user. Finally, the fastener can be secured to the fastener of a sprinkler body at the second end.

Accordingly, the dual-size sprinkler head riser device of the present invention is particularly advantageous as it provides a device that allows a sprinkler head to be easily replaced and can be used to raise a sunken sprinkler. The device also provides connection points that can accommodate two different diameters of sprinkler bodies and pipes. In addition, the device can be easily replaced by a user. In this manner, the dual-size sprinkler head riser device overcomes the limitations of existing methods and devices used for sprinkler and pipe attachment known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a dual-size sprinkler head riser device of the present invention in accordance with the disclosed architecture;

FIG. 2 illustrates an exploded view of one potential embodiment of a dual-size sprinkler head riser device of the present invention in accordance with the disclosed architecture;

FIG. 3 illustrates a perspective view of one potential embodiment of a dual-size sprinkler head riser device of the present invention while attached to an elbow pipe and a sprinkler head in accordance with the disclosed architecture;

FIG. 4 illustrates a flowchart of a method of using one potential embodiment of a dual-size sprinkler head riser device of the present invention in accordance with the disclosed architecture; and

FIG. 5 illustrates a flowchart of a method of using one potential embodiment of a dual-size sprinkler head riser device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that allows a broken sprinkler head to be easily replaced and can be used to raise a sunken sprinkler if needed. There also exists a long-felt need in the art for a dual-size sprinkler head riser device. More specifically, there exists a long-felt need in the art for a dual-size sprinkler head riser device that provides connection points that can accommodate two different diameters of sprinkler bodies and funny elbows connected to water pipelines. In addition, there exists a long-felt need in the art for a dual-size sprinkler head riser device that can be easily replaced by a user without added labor or expenses.

The present invention, in one exemplary embodiment, is comprised of a dual-size sprinkler head riser device primarily comprised of a body with a first end and a second end. The first end is comprised of at least one fastener that allows a sprinkler body to attach to the device. The first end and second end preferably differ in diameter to allow easy attachment to sprinkler bodies and elbow pipes to raise sprinkler bodies that have sunk too low into the ground.

The body is preferably tubular and hollow to allow fluid to travel from an elbow pipe, through the body, and to a sprinkler body. The first end of the body is comprised of at least one opening, wherein the interior surface of the opening is comprised of at least one fastener that allows the first end to attach to at least one fastener of an elbow pipe. The opening is preferably of a first diameter.

The second end of the body is also comprised of at least one opening of a second diameter, wherein the exterior surface of the body is preferably comprised of at least one fastener that allows the second end of the body to attach to a fastener of a sprinkler. The opening is preferably of a second diameter. As a result of the presence of the fastener on the exterior surface of the body, the body can be cut to size by a user in order to achieve the proper body height needed for the sprinkler and elbow pipe connection. In various embodiments, the diameters of each opening may be identical or different in order to facilitate attachment with any different diameters of elbow pipe and sprinkler body known in the art.

The present invention is also comprised of a method of using the device. First, a device is provided comprised of a body comprised of an exterior surface comprised of a fastener, a first end with an opening comprised of at least one fastener, and a second end comprised of an opening. Then, a fastener of an elbow pipe can be secured to a fastener of the first end. Finally, the fastener can be secured to the fastener of a sprinkler body at the second end.

The present invention is also comprised of a second method of using the device. First, a device is provided comprised of a body comprised of an exterior surface comprised of a fastener, a first end with an opening comprised of at least one fastener, and a second end comprised of an opening. Then, a fastener of an elbow pipe can be secured to a fastener of the first end. Next, the body can be cut to the desired size by a user. Finally, the fastener can be secured to the fastener of a sprinkler body at the second end.

Accordingly, the dual-size sprinkler head riser device of the present invention is particularly advantageous as it provides a device that allows a sprinkler head to be easily replaced and can be used to raise a sunken sprinkler. The device also provides connection points that can accommodate two different diameters of sprinkler head bodies and funny elbows. In addition, the device can be easily replaced by a user. In this manner, the dual-size sprinkler head riser device overcomes the limitations of existing methods and devices used for sprinkler head and pipe attachment known in the art.

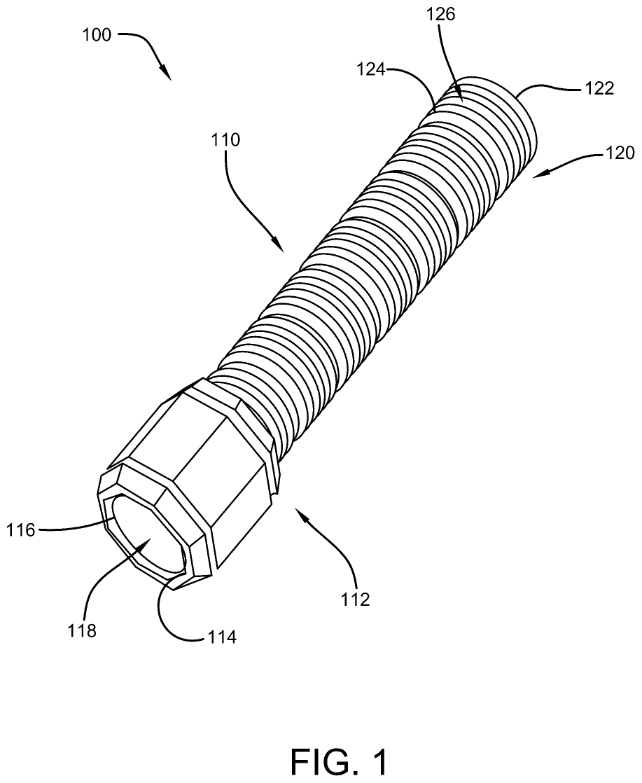

Referring initially to the drawings, FIG. 1 illustrates a perspective view of one potential embodiment of a dual-size sprinkler head riser device 100 of the present invention in accordance with the disclosed architecture. The device 100 is primarily comprised of a body 110 with a first end 112 and a second end 120. The first end 112 is comprised of at least one fastener 118 that allows a sprinkler body 10 to attach to the device 100. The first end 112 and second end 120 preferably differ in diameter to allow easy attachment to sprinkler bodies 10 and elbow pipes 20 to raise sprinkler bodies 10 that have sunk too low into the ground.

The device 100 is preferably comprised of a PVC, plastic, or other material of the like that may be flexible or rigid. In one embodiment, the body 110 is comprised of a molded polyethylene that can be cut to size. The body 110 is preferably tubular and hollow to allow fluid to travel from an elbow pipe 20, through the body 110, and to a sprinkler body 10. However, the body 110 may be any shape. The body 110 may be any length in different embodiments. In one embodiment, the body 110 is made from a flexible tubing.

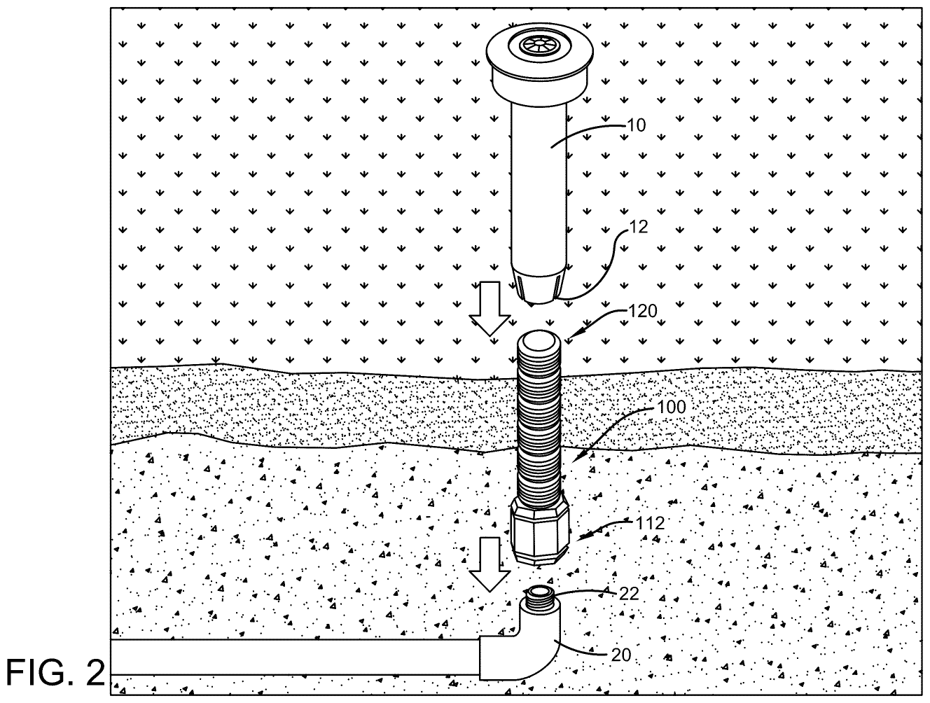

The first end 112 of the body 110 is comprised of at least one opening 114. The interior surface 116 (or in one embodiment, the exterior surface) of the opening 114 is comprised of at least one fastener 118. The fastener 118 is preferably a plurality of male or female threads. However, the fastener 118 may be any type known in the art such as, but not limited to, tongue and groove, magnetic, etc. The fastener 118 allows the first end 112 to attach to at least one fastener 22 of an elbow pipe 20 (wherein the fastener 22 is shown in FIG. 2). The opening 114 is preferably of a first diameter, such as, but not limited to, ¾″ or ½″.

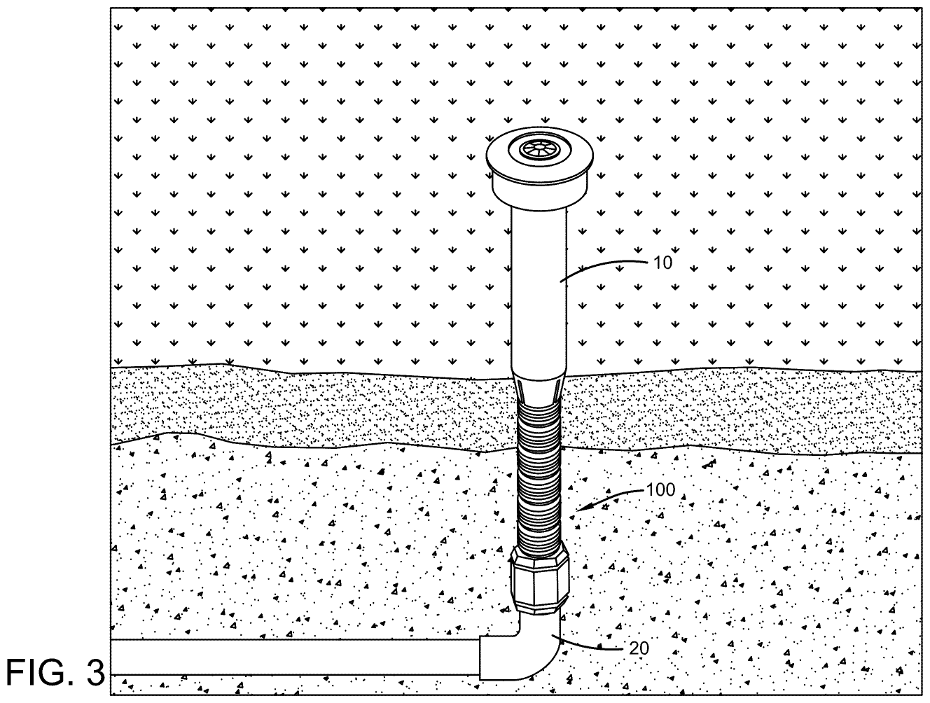

The second end 120 of the body 110 is also comprised of at least one opening 122. The exterior surface 124 (or interior surface) of the body 110 is preferably comprised of at least one fastener 126. The fastener 126 is preferably a plurality of male or female threads. However, the fastener 126 may be any type known in the art such as, but not limited to, tongue and groove, magnetic, etc. The fastener 126 allows the second end 120 of the body 110 to attach to a fastener 12 of a sprinkler body 10, as seen in FIG. 3. The opening 122 is preferably of a second diameter, such as, but not limited to, ¾″ or ½″. As a result of the presence of the fastener 126 on the exterior surface 124 of the body 110, the body 110 can be cut to size by a user in order to achieve the proper body 110 height needed for sprinkler 10 and elbow pipe 20 connection.

In various embodiments, the diameters of each opening 114, 122 may be identical or different in order to facilitate attachment with any different diameters of elbow pipe 20 and sprinkler body 110 known in the art. In the preferred embodiment, the opening 114 has a ¾″ diameter and the second opening 122 comprises of a ½″ diameter. By way of example, both openings 114, 122 may be ½″ or ¾″ in diameter, or either opening 114, 122 may be ½″ or ¾″. However, it should be appreciated that the diameters of each opening 114, 122 may be any diameter in different embodiments. Each end 112,120 may also be male or female.

By further way of example, in a scenario wherein a funny elbow 20 attached to the water pipeline has a ½″ male connection and wherein a replacement sprinkler head has a ¾″ female connection, the first end 112 is comprised of a female ½″ threaded fastener 118 which receives the male connection of the elbow 20. Then, the second end 120 of the device 100 is comprised of a ¾″ male fastener 126 to receive the female ¾″ end of a replacement sprinkler body 10.

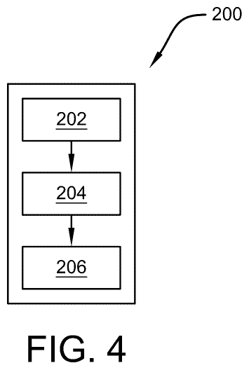

The present invention is also comprised of a method of using 200 the device 100, as seen in FIG. 4. First, a device 100 is provided comprised of a body 110 comprised of an exterior surface 124 comprised of a fastener 126, a first end 112 with an opening 114 comprised of at least one fastener 118, and a second end 120 comprised of an opening 122 [Step 202]. Then, a fastener 22 of an elbow pipe 20 can be secured to a fastener 118 of the first end 112 [Step 204]. Finally, the fastener 126 can be secured to the fastener 12 of a sprinkler body 10 at the second end 120 [Step 206].

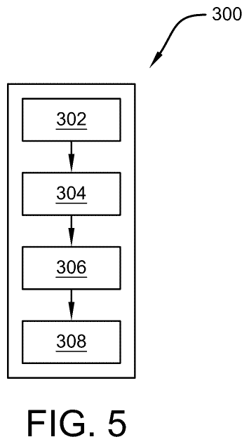

The present invention is also comprised of a second method of using 300 the device 100, as seen in FIG. 5. First, a device 100 is provided comprised of a body 110 comprised of an exterior surface 124 comprised of a fastener 126, a first end 112 with an opening 114 comprised of at least one fastener 118, and a second end 120 comprised of an opening 122 [Step 302]. Then, a fastener 22 of an elbow pipe 20 can be secured to a fastener 118 of the first end 112 [Step 204]. Next, the body 110 can be cut to the desired size by a user [Step 306]. Finally, the fastener 126 can be secured to the fastener 12 of a sprinkler body 10 at the second end 120 [Step 308].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “dual-size sprinkler head riser device” and “device” are interchangeable and refer to the dual-size sprinkler head riser device 100 of the present invention.

Notwithstanding the foregoing, the dual-size sprinkler head riser device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the dual-size sprinkler head riser device 100 as shown in the FIGS. are for illustrative purposes only, and that many other sizes and shapes of the dual-size sprinkler head riser device 100 are well within the scope of the present disclosure. Although the dimensions of the dual-size sprinkler head riser device 100 are important design parameters for user convenience, the dual-size sprinkler head riser device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A dual-size sprinkler head riser device comprising:
a body comprised of a first end comprised of a female threaded opening and a second end comprised of a male threaded opening;
a first fastener positioned on an exterior surface of the body; and
a second fastener positioned on an interior surface of the first opening.

2. The dual-size sprinkler head riser device of claim 1, wherein the female threaded opening is comprised of a first diameter and the male threaded opening is comprised of a second diameter.

3. The dual-size sprinkler head riser device of claim 2, wherein the first diameter or the second diameter have a diameter of ½″.

4. The dual-size sprinkler head riser device of claim 2, wherein the first diameter or the second diameter have a diameter of ¾″.

5. The dual-size sprinkler head riser device of claim 1, wherein the body is comprised of a hollow body.

6. The dual-size sprinkler head riser device of claim 1, wherein the body is comprised of a molded polyethylene that can be cut or a flexible PVC.

7. The dual-size sprinkler head riser device of claim 1, wherein the first fastener is comprised of a female thread.

8. The dual-size sprinkler head riser device of claim 1, wherein the second fastener is comprised of a male thread.

9. A dual-size sprinkler head riser device comprising:
a body comprised of a first end comprised of a first opening of a first diameter and a second end comprised of a second opening comprised of a second diameter;
a first fastener positioned on an exterior surface of the body; and
a second fastener positioned on an interior surface of the first opening.

10. The dual-size sprinkler head riser device of claim 9, wherein the first diameter is ½″ and the first opening is comprised of a female opening.

11. The dual-size sprinkler head riser device of claim 9, wherein the second diameter is ½″ and the second opening is comprised of a male opening.

12. The dual-size sprinkler head riser device of claim 9, wherein the first diameter is ¾″ and the first opening is comprised of a female opening.

13. The dual-size sprinkler head riser device of claim 9, wherein the second diameter is ¾″ and the second opening is comprised of a male opening.

14. The dual-size sprinkler head riser device of claim 9, wherein the first fastener is comprised of a thread.

15. The dual-size sprinkler head riser device of claim 14, wherein the first fastener is comprised of a male thread or a female thread.

16. The dual-size sprinkler head riser device of claim 9, wherein the second fastener is comprised of a thread.

17. The dual-size sprinkler head riser device of claim 16, wherein the first fastener is comprised of a male thread or a female thread.

18. A method of using a dual-size sprinkler head riser device, the method comprising the following steps:
providing a dual-size sprinkler head riser device comprised of a body comprised of an exterior surface comprised of a first fastener, a first end comprised of a first opening comprised of a second fastener, and a second end comprised of a second opening;
securing an elbow pipe fastener of an elbow pipe to the second fastener of the first end; and
securing the first fastener to a sprinkler body fastener of a sprinkler body at the second end.

19. The method of using a dual-size sprinkler head riser device of claim 18 further comprised of a step of cutting the body.

20. The method of using a dual-size sprinkler head riser device of claim 18, wherein a first diameter of the first opening differs in size from a second diameter of the second opening.
